(19) United States
(12) Patent Application Publication
(10) Pub. No.: US 2006/0166740 A1
(43) Pub. Date: Jul. 27, 2006

(54) Method and system for identifying, matching and transacting information among portable devices within radio frequency proximity

(76) Inventor: Joaquin Sufuentes, Portland, OR (US)

Correspondence Address: JOAQUIN SUFUENTES, 3055 NW RIO VISTA TERRACE, PORTLAND, OR, 97210, US

(21) Appl. No.: 10/794,859

(22) Filed: Mar. 8, 2004

(51) Int. Cl. A63F 13/00

(52) U.S. Cl. 463/40; 463/42

(57) ABSTRACT

In today's increasingly populated, yet very busy world, there is a growing need to create community and enable an efficient flow of information through shared interactions; such as matching, alerting, gaming, and commerce. Interactions can be facilitated by advancing technology and the proliferation of wireless devices. Wireless devices and applications can facilitate the matching of people based on similar characteristics, token and data exchanges for gaming situations, or the sending of alerts to warn those entering hazardous areas. With the advent of inexpensive radio frequency (RF) chips and wireless communication standards of many forms, microprocessors (and computing ASICs), and flash memory embedded in many common devices, it is possible to increase the amount of automatic person to person interaction as people pass within RF range of the devices they carry with them or which may reside in fixed locations. The utility of the present invention will describe an application and system whereby current and future portable devices; such as mobile phones, personal digital assistants, pagers, AM/FM radios, music players, key fobs, watches, video playback devices, etc. will seamlessly interact to share information. The utility to the user is derived from systems' ability to match, alert, transact commerce and gaming within a system requiring little to no user intervention beyond the initial configuration. It is anticipated that with the technology described within the current invention: two people will be able to meet in a public setting as they pass each other because they have shared commonalities; individuals will be alerted to hazardous circumstances, perhaps a convicted sex offender in the area, construction zone, or approaching accident scene; groups of people will enjoy gaming opportunities by playing virtual tag with electronic tokens, until the winner is finally tagged; and users will be able to purchase digital content, such as songs, videos, or other streamed or broadcast media, by merely pressing a button on the receiving device. The utility of the current invention will further describe the application and systems which can be made available in a highly portable device or embedded into a host of commercially available devices.

### FIELD OF THE INVENTION

The present invention relates generally to a method and system for enabling personal area networks for matching, alerting, queuing, gaming and commerce transactions between devices and people within radio frequency proximity, and coupled with services provided over wide area communications networks, including broadcast as well as two way communications.

### BACKGROUND

In today's mobile society, people often circulate rapidly within environments and have little to no time to either meet people with common interests, be alerted to potentially hazardous situations, benefit from being in certain places at certain times (situational games) or gain access to digital content available through personal area networks or extranets (including broadcasts). The amount of information which people would have to interchange with each other to find commonalities of tastes, opinions, likes and dislikes, means that most often people are more likely to walk past each other, past a store, past a street vendor, past a street performer), etc., then to stop and engage that person or enter that establishment. And yet every missed connection, for lack of time, is a missed opportunity to benefit from meeting someone. Likewise not every connection or environment people travel in is safe or beneficial. Knowing when to discern a good connection from a bad situation need not always be left to chance.

By enabling people with valued added content on the devices they travel with now and those they will travel with in the future; such as mobile phones, personal digital assistants (PDAs), pagers, AM/FM radios, music players, key fobs, watches, video playback devices, laptops, etc; the current invention can turn public encounters and environments into safer places to meet, learn, and transact commerce and gaming opportunities.

The utility embodied in the current invention will allow people to meet when circulating within radio frequency proximity to each other while carrying their enabled devices which will emit a noise, visual or tactile cue when a matching profile on another person's device is detected. One embodiment of the current invention housed on a Bluetooth enabled mobile phone is a particularly compelling device to perform the systematic check for matching characteristics. This mutual acknowledgment in public settings can embolden people to stop, meet, and greet to find the source of their commonality, whether searching for a relationship, business opportunity, a subject matter enthusiast or to join a forming group. The current invention also allows for the quick exchange of information if time does not allow for further discussion.

Likewise, the current invention is useful in warning of impending hazards when alerts from other users, known offenders with beacons or stationary devices broadcast alerts to other devices in the immediate vicinity. One example of the alert capability is illustrated by the need to know where sex offenders are housed in a community. Sometimes they are provided a global positioning system (GPS) bracelet to gage their geographic movements. If the bracelet were provided an RF broadcast chip (such as Bluetooth or Wifi) then it could anonymously broadcast alerts to neighboring devices so that people in areas where the offender commuted would be more vigilant when their mobile device (such as cell phone, PDA or laptop) sounded a proximity alert. In this case, the current invention would allow for anonymity for the offender, yet heightened awareness by others. Additionally, a construction company could place RF broadcast devices near construction sites to warn people to be vigilant as they approach scaffolding, digging or a demolition site.

Another form of helpful alert which the current invention speaks to is that of announcing a position in a queue. For a user of the invention waiting for a seat at a restaurant, the software application on the mobile device, or applet, can communicate the number of people in his or her party to a fixed device (such as a credit card authorization modem, or other wireless enabled device) on the premises. Then once the table is available the premise device can signal the personal unit (cellphone, PDA, etc) used by the customer, that the table is ready. The same functionality can work in queue management for amusement parks to help eliminate the need for lines and increase circulation within the park. To notify customers that have moved outside the personal devices' radio range of queue positions, the personal device will optimally have a wide area network connection, such as GSM/GPRS, CDMA, paging, etc, as well as a personal area RF capability, such as Bluetooth, Wifi, etc.

Promoting fun associations is also a function of the current invention. The same system and apparatus which affords people the opportunity to meet or be on alert, also can transact gaming tokens which can serve as a lottery or prize competition. One of the most basic games played as a child is tag. The same game adapted to the electronic age can serve not only to entertain but create a gaming culture and brand awareness promotions for corporations. In the gaming component of the current invention a token is passed, or launched, to a mobile device which then gets passed onto another applet on another participating device, and so on, until the token reaches the number of hops it was encoded for and alerts the winner. All along the way, each tagged individual may be alerted, or not to the fact that he or she holds the token. A form of the game may be fun to track via a geographic map on the web, wherein a token can send a message back to a server to announce its general position without the user knowing that he or she has it. In this instance of the game, a token may be launched in New York and be tracked making it's way across the country as the token is switched off via many user devices. The applet which holds and passes the token may be sold like a lottery ticket for an individual user to gain a chance at holding the token. The game may also be played in one site or venue, by having fixed devices recover tags from people who are exiting the boundaries of the site and recirculating them to people entering or already in the site. States or countries may launch lotteries in this format. Corporations or individuals may provide prizes. The gaming utility of the current invention can serve to foster circulation of people within a site or venue, and create a new method to promote products or marketing campaigns.

Another opportunity for the utility of the current invention to be realized is in the transaction of commerce within personal area networks and wide area networks. Within personal networks, those which are formed in an ad hoc fashion as a person travels in public locations, passers by or street vendors may advertise or promote content for sale, such as pictures, music, videos, ringtones, etc that they or their devices hold and can dispense. If a user using the matching applet describes the type of content, or product, he or she would like to be alerted to, when a match is found of someone offering it in the local area, the two parties can meet. If the potential buyer approves of the content or product, the product can be transferred to the buyer (or in case of digital content by copying or transferring with the digital rights) from the seller. The payment may be made by the buyer's applet sending the seller a wide area network payment, such as Visa, MC, Paypal, etc, or exchanging a local area token with a pin code to the seller, who can then synchronize it later via the web to have his account credited.

In the example of broadcast content for purchase, the user is listening to a radio broadcast on his portable device, in which case he chooses to purchase the song to retain in the memory or storage of his device. Via one-click in the applet of the current invention, a transaction may be initiated between the listener (now the buyer) of the content and the broadcaster or service provider. A payment transaction is created with the broadcaster, or third party handling the content to be sold, and once payment is confirmed the buyer receives a digital stream to the device he used to purchase the content. In the case of digital radio the stream may be sent via excess spectrum afforded to the digital radio operator, which broadcasts it to all users in the service area, but only those who have purchased the song would receive the key to decrypt and store the content. This same operation would work for digital television broadcasts of programs to personal video playback devices. Additionally, the wide area network capability can be used to download the content, but it might take much longer on certain networks (such as GSM/GPRS, CDMA, or paging networks).

The method and system of the current invention allow a flexible framework to match people with people and with content; alert them of hazards, queue placement, and other topics; the current invention afford users gaming opportunities; and provide for commercial transactions of digital content.

### SUMMARY OF THE CURRENT INVENTION

The utility of the current invention speaks to a system which can be enabled in a variety of mobile devices currently available today, by combining minimal processing of application instruction sets, with capacity for storing small datasets, a radio unit with standardized protocols to communicate to other devices in radio proximity and a radio unit to provide wider area connectivity for access to system resources from financial institutions and other service providers. These components optimized for low power consumption and controlled by a small software application or applet can extend extraordinary functionality to people's lives.

People will be able to take their mobile phones, which already possess some of the device requirements of the present invention, load an applet and begin meeting people with similar likes and dislikes, hobbies, career goals, and social habits. An applet on a mobile phone can constantly scan its surroundings using Bluetooth today, and Wifi tomorrow, and Zigbee or another low power standard in the future. Scanning the surrounding area allows the applet to discover similarly capable devices and people. A user could enter a field on the applet requesting a dinner companion for the evening, and as he walks through town, a similarly minded person has the date for the evening symbolically listed as open. Both devices announce their match to their owners. The device owners take it from there. If they are out of sight, the applet would open a voice session for the two people to speak.

In a further embodiment of the utility of the current invention, an applet may be configured to scan for alerts in the vicinity. Construction sites may use stationary devices on construction barriers (since they have batteries on the lights already) to warn people in radio proximity. Police organizations may use applets on bracelets for sex offenders released to the community. Electronic radio beacons announce the alert to people in the vicinity with the scanning applet enabled on their mobile phones. The user with the beacon would remain anonymous while people in the vicinity would be more vigilant.

Another embodiment of the current invention speaks to the gaming opportunities inherent in a system which can pass tokens from person to person as in a virtual game of tag. The token would circulate until it was activated from a service provider to notify a winner, or until he had reached a pre-defined number of hops from device to device. Across a wide geography, audiences would be able to follow the progress of the token via the web. In closed settings a token could be launched to get people to circulate within an amusement park, casino, or other entertainment venue. Stationary devices at the doors would assure no token left the premises until it tagged a winner.

A further embodiment speaks to the need for queue management in restaurants, amusement parks, and areas where people frequently encounter wait times for service. In a restaurant, the patrons use their mobile applet to upload contact information to a queue manager device. The patron subsequently receives a call, page, e-mail, whatever their preference when the table is ready. Additionally, placing two or more queue manager applets in stationary devices around the restaurant allows for tracking of people flow by the triangulation of the mobile device to the stationary devices. An algorithm allows the applet to offer very precise wait times for new customers entering a restaurant.

Another embodiment of the current invention addresses the need for creating opportunities for commercial transactions in personal areas. Just as posting a car for sale on well traveled roads would more than likely lead to a sale, so to would circulating around a city with an applet announcing ask-offer products and services to passersby, without interrupting anyone. If a seller's offer met a buyer's ask, they would be notified and a conversation would ensue. Symbolic characterization of data works better in this instance than keyword matching. Ultimately, the applet allows for contact information to be exchanged automatically for further conversation between a buyer and seller, or a transaction payment to be initiated across a wide area communication channel, such a paging, SMS, or GPRS.

Another option for commerce transaction utilizing the utility of the current invention, is in the purchase of digital content. With an AM/FM radio, MP3 player, personal video player, etc incorporating a commerce applet and wide area connectivity, content that came to the device via a broadcast or stream would be available purchase with the push of a single button. The transaction would be confirmed over a data network, such as paging service, and the content broadcast over an available frequency to all users who purchased the content. Decryption and use are managed by a key sent to the device upon payment confirmation over the data network.

The current invention teaches to a system and method for creating value enhanced personal area networks and commerce enhanced wide are communications.

### BRIEF DESCRIPTION OF THE DRAWINGS

The novel features which are characteristic of the invention are set forth with particularity in the appended claims. The invention itself, however, both as to organization and operation together with further objects and advantages thereof may best be understood by references to the following description taken in conjunction with the drawings in which:

FIG. 1 is an embodiment of a portable communications device with transparent view of the internal component requirements of the current invention.

FIG. 2 is a further embodiment of a portable device with transparent view of the internal component requirement of the current invention.

FIG. 2A is a flowchart of an example system process for exchanging match data, proximity alerts, gaming tokens, queue management and commercial transactions

FIG. 3 is an embodiment of a stationary device, with transparent view of the internal component requirements for providing personal and wide area data exchange with the portable devices of FIG. 1 and FIG. 2.

FIG. 4 illustrates the system methodology provided by the current invention for matching people with commonly defined characteristics using portable devices.

FIG. 5 illustrates the system methodology provided by the current invention for alerting people of hazardous areas utilizing the portable devices.

FIG. 6 illustrates the system methodology provided by the current invention for alerting people to be vigilant utilizing the portable devices.

FIG. 7 illustrates the system methodology provided by the current invention for managing queues utilizing the portable devices.

FIG. 8 illustrates the system methodology provided by the current invention for offering gaming solutions utilizing the portable devices.

FIG. 9 illustrates the system methodology provided by the current invention for conducting personal area commercial transactions with concurrent wide area transaction approval utilizing portable devices.

FIG. 10 illustrates the system methodology provided by the current invention for conducting personal area commercial transactions with transaction completion occurring at a future time with portable devices.

FIG. 11 illustrates the system methodology provided by the current invention for purchasing broadcast or streamed digital content through an out of band transaction completion method with portable devices.

### DETAILED DESCRIPTION OF A PREFERRED EMBODIMENT

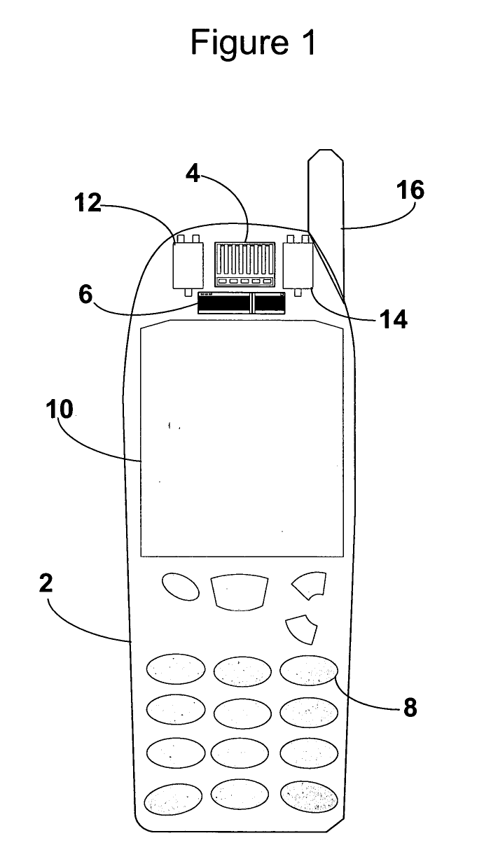

FIG. 1 illustrates a portable communications device 2 with a transparent view allowing for the symbolic depiction of the necessary components to support the apparatus of the current invention. The utility of the apparatus of the current invention speaks to a software application and system configured with algorithms and coded instruction sets to perform important security, communication, processing, analytic and storing tasks upon data which is input to the application via the portable device 2 by the user through a user interface or other devices in radio proximity through a wireless connection. The software application, or applet, resides on the apparatus in a memory space of the processing module 4 or the memory module 6 where the processing unit 4 may call upon it. The applet may be configured by a user through touch pad 8 input and cues from a screen 10. The touch pad 8 may be but is not limited to pen based, alphanumeric or symbolic; with arrows or other symbols to navigate menu items. The screen 10 may be but is not limited to a liquid crystal display, light emitting diode, or organic light emitting diode. The applet, when enabled and configured in the apparatus, uses a personal area communications module 12 to announce its presence to similarly configured devices in radio proximity. The personal area communications module 12 may represent, but is not limited to, a Bluetooth, Zigbee, Wifi or other wireless chipset for low power consumption, low range radio with a standardized protocol for device to device communication. A wide area communications module 14, utilizing antenna 16 for radio frequency transmission, shall also be available on the device to enable voice and data communications across a large cellular infrastructure.

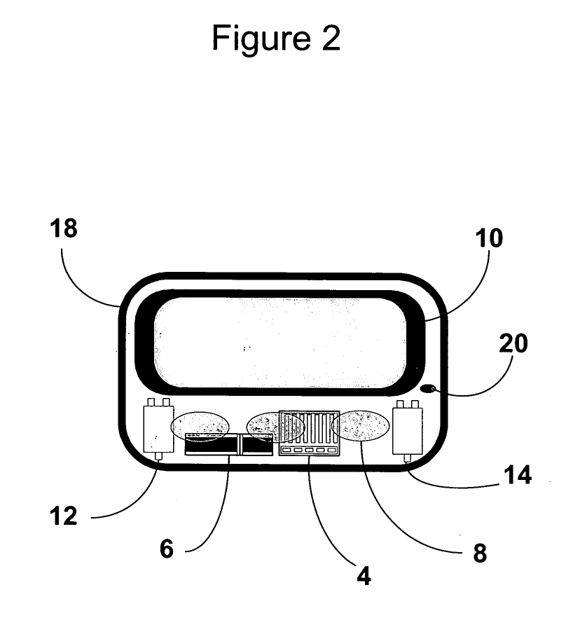

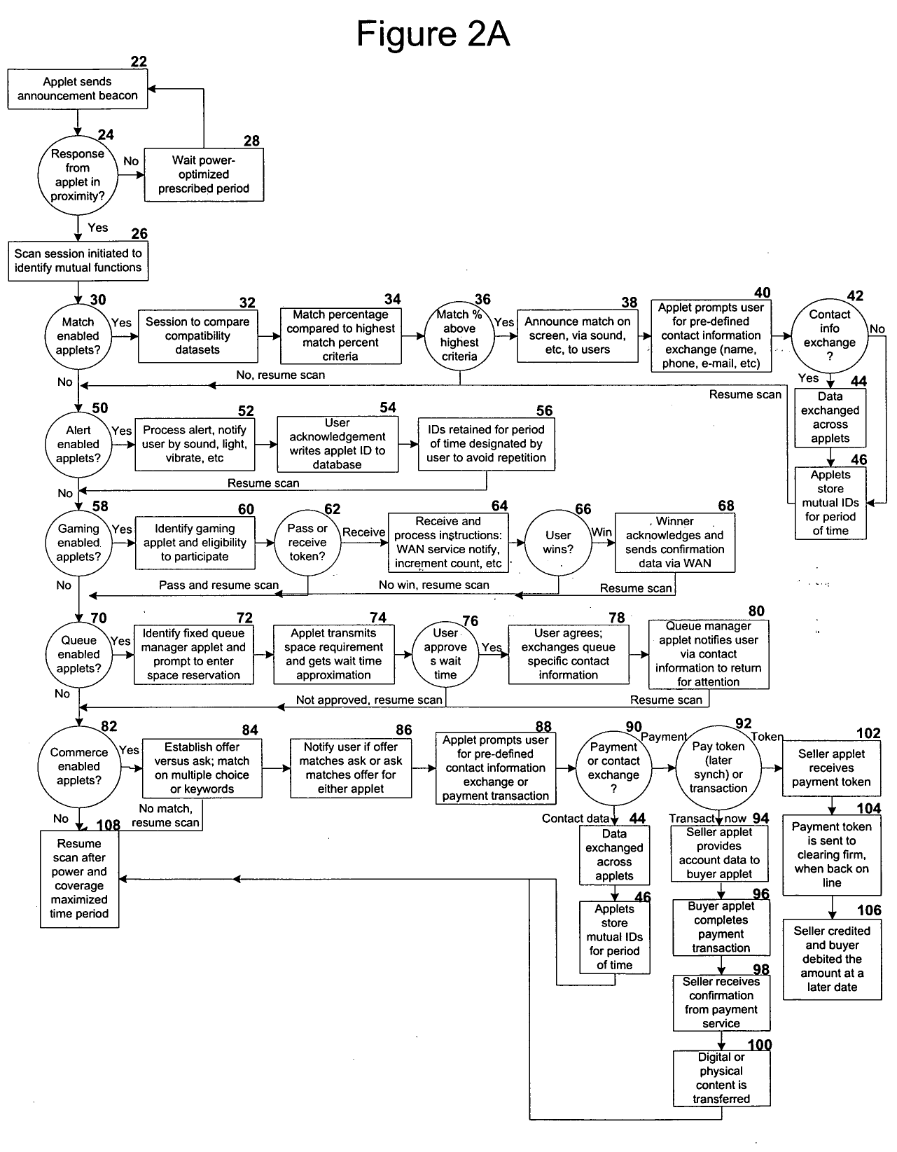

FIG. 2 is a further embodiment of a portable wireless apparatus as taught by the current invention. The portable pocket device 18 contains a processing module 4 to process application instructions and data sets loaded from a memory module 6. A personal area communications module 12 scans the environment for other similarly configured devices. A wide area communications module 14 allows access for two way data services over broad radio networks, such as, but not limited to cellular, paging, or broadcast frequencies. A touch pad 8 for user input to the system is provided for symbolic and menu driven data input. A screen 10 allows information to be viewed and the applet to be configured by the user. For audio alerts, a sound output module 20 is incorporated in the device.

FIG. 2A illustrates a flowchart diagram as an example of the broad system utility and role of the applet in the current invention. An applet announces it presence through a beacon alert 22. When not announcing or engaged in a session, the applet is listening for beacons in the environment. The beacon ideally is power optimized to signal in intervals equal to the time an average pedestrian in the local geography takes to walk two times the radius of the maximum coverage area for the personal area communications module. If a response to a beacon is received from another apparatus in proximity 24, a scan session is initiated 26 to identify the mutual functions of each applet on the apparatus. If no response to a beacon is detected 24 or no new beacon from another apparatus is apparent, the applet waits a power optimized amount of time 28 to send another beacon 22.

A scan session 26 initiates to identify the applet services enabled. For this flowchart example no specific is advocated, any order is for illustrative purposes only, and the scan order may be user defined. When a match enabled applet is detected 30, a session to compare compatibility datasets 32 initiates. The percentage match for the data exchanged is derived by taking the total criteria scanned and dividing into the number of criteria which match on each system. The match percentage is compared to the minimum match threshold defined by each user 34. If user 1 has a 50% match threshold and user 2 a threshold of 70%, then no match notification is made to either user by the applet unless the matched criteria is over the 70% threshold. If the match criteria percentage is below the minimum threshold 36, the applet functionality scan continues 50. If minimum threshold is exceeded both applets announce a match 38 using the audio-visual-tactile cues defined by the each user. After announcement of the match, each user is asked if they want to exchange contact information 40. The contact information to exchange is user defined. The utility of having the data exchanged automatically, at a press of a button is assumed to occur after both parties meet and speak. The utility of the current invention allows users, in a hurry, on their way to appointments to exchange contact data quickly for later conversation. If users decide to exchange contact information 42, the applets exchange the pre-defined user data 44. Then the applets store the unique applet identifier 46 of each other for a user defined period of time to avoid having another match occur in a short period of time.

Scan session 26 continues to define applet functionality by scanning for the alert enablement 50. If the beacon detected is from an alert applet conveying information, the information is immediately processed and displayed for the user 52, through visual-audio-tactile cues. Further to the utility of the current invention, the applet and system will allow for a prompt to the user when the apparatus is in use for another purpose, such as, but not limited to a voice call, game playing, picture-taking, etc. A user acknowledgment 54 to the system via a keypad touch, triggers the applet identifier from the alerting applet to be stored to the receiving applet database. The applet identifier is stored for a user defined period of time 56 to avoid repetitive alerts within a short interval.

Scan session 26 continues to define applet functionality by scanning for gaming enablement 58. Identifying eligibility of the receiving applet 60 for a specific game is important as there may be many games occurring in one geographic area. An applet will also have a community gaming space available for non-closed, non-restricted audiences. The applet confirms a pass along of a gaming token or the receipt of a gaming token 62. When an applet receives a new gaming token it un-encrypts, opens and processes the instruction set 64 within the token. A primary instruction may be to send a positioning update to a server on the internet in order to track the progress of the token. A web site with a progress map would elicit excitement from people when a token arrives in their neighborhood. Additionally, the token may have a counter which relates when it announces the winning hop 66, or it may take the cue from the central server to which the applet reports geographic positioning. If the user on the subsequent hop wins 66, visual-audio-tactile cues from the apparatus would inform the user and the applet would notify a internet connected server to announce the winner, if the server had not been used to perform the incremental count. No win designation from processing the instruction set would lead the applet to continue to scan for other enabled services 26.

Scan sessions discovering a queue enabled applet 70, on a hospitality device, prompt the user of the mobile apparatus to enter a space number 72, signifying the number of people in the party. The user applet transmits the space number to the queue manager applet in the hospitality device and is returned an approximate wait time 74. The user may approve the wait time 76 and submit contact information 78 to the queue manager applet or not approve and exit the area. If approved by the user, the user applet then sends preferred contact information to the queue manager 78 and awaits further contact. The contact information shared with the queue manager will in the preferred embodiment of the current invention be a contact mechanism via a wide area communication connection, such as, but not limited to a mobile phone number for the apparatus on which the applet resides, a pager number to another device or the apparatus on which the applet resides, an e-mail address for a user device or the apparatus on which the applet resides. The queue manager subsequently notifies the user via the contact information when space is available 80. The queue manager apparatus as taught by the current invention would ideally have an automated mechanism for tracking space availability, for queues in amusement parks and other large venues, or a screen and touchpad for interface to a person at smaller venues, such as a restaurant, salon, shopping area, and so forth.

Scan sessions which encounter a commerce enabled applet 82, establish a connection and commence an offer versus ask comparison 84. Each applet containing user defined fields for ask versus offered products and services would compare criteria based on keyword or predefined choices. An applet signals the user of the apparatus that an ask-offer match is made 86 using audio-visual-tactile cues. An applet then offers the ability to exchange contact information for further conversation, or create a payment transaction 88 for a product or service. The payment option being chosen 90 leads to an option to create an instant payment transaction or a payment token 92 which may be synchronized at a future date to receive payment. An immediate payment transaction signals the seller applet to send routing information for the seller's payment clearinghouse to the buyer applet 94. The payment clearinghouse may be, but is not limited to a bank, credit card provider, PayPal, or other on-line billing service. The buyer's applet takes the payment routing information and after the buyer enters an amount to the applet, sends a payment processing request to the seller's clearinghouse 96 over the wide area communication infrastructure. The seller receives a confirmation from the clearinghouse over the wide area connection 98. Subsequently the product or service; digital or other medium, is transacted 100. If the buyer or seller does not have an apparatus as defined by the current invention, with wide area connectivity, then the buyer can send an encrypted payment token with the amount and a personal identification code encrypted to the seller 102, and the seller's apparatus having later been connected to wide area by a wire or the personal area communications module can then send the token to the clearinghouse 104 for processing and credit to the seller's account 106. If only contact information is exchanged 90, then the process for exchanging the user-defined contact information is similar to the match applet information exchange across applets 44. Applet beacon announcement resume after a power optimized waiting period has transpired from the last scan, transaction completion or beacon alert 108.

A preferred embodiment of the current invention speaks to a system for matching people within radio frequency proximity utilizing keyword and symbolic question-response comparisons. An applet utilized for matching a user to other users in radio proximity would have data populated via a direct interface on the apparatus wherein the applet resides, or via an interface with a computer program, such as, but not limited to: html, java, and visual basic, wherein a user would respond to multiple-choice questions posed by the system. User responses to the questions would be downloaded to the apparatus in conjunction with the applet or after the applet is resident on the apparatus.

In a preferred embodiment of the current invention the database of match criteria would store symbolic information allowing for broad geographic, cultural and ethnic applicability for comparison criteria. As an example; questions would include a favorite color, favorite food, favorite book, favorite vacation destination, etc. The symbolic question and response characteristics would be selected for ease of interrelation from user to user, or region to region, language to language, or culture to culture. Symbolic interrelation speaks to the utility of the current embodiment, as a single applet and interface will enable a plurality users, varying in age, culture, ethnicity, race, and with other socially distinguishing features.

A symbolic question-response mechanism utilizes similar questions with multiple-choice answers that may be similar in context though not exact in response. Responses are then mapped one to the other by the similarity of their context, through a numeric value or key word contained by the applet.

As an example, the following are three questions with their multiple-choice responses:
1) What is your favorite food (responses for someone in the US, perhaps):
   a. French fries
   b. Ice Cream
   c. Steak
   d. Salad
2) What is your favorite food (responses for someone in the Asia, perhaps):
   a. Pot Stickers
   b. Mango Pudding
   c. Mongolian Beef
   d. Green Papaya
3) Que comida prefieres (responses for someone in a Spanish speaking country):
   a. Papas fritas
   b. Helado
   c. Biste
   d. Ensalada

The questions are constructed similarly though the responses vary culturally, ethnically, geographically or due to other social characteristics; the questions and responses, when mapped to a common variable, can then be normalized and compared. The following is an example of symbolic response standardization:

| | | |
|---|---|---|
| 1) | What is your favorite | Question Mapped: Favorite: 1, Food: 10 |
| | food? | |
| | a. French Fries | Response Mapped: Fried food: 12 |
| | b. Ice Cream | Response Mapped: Dessert food: 15 |
| | c. Steak | Response Mapped: Red Meat food: 13 |
| | d. Salad | Response Mapped: Raw Vegetable/Fruit: 19 |
| 2) | What is your favorite | Question Mapped: Favorite: 1, Food: 10 |
| | food? | |
| | a. Pot Stickers | Response Mapped: Fried food: 12 |
| | b. Mango Pudding | Response Mapped: Dessert food: 15 |
| | c. Mongolian Beef | Response Mapped: Red Meat food: 13 |
| | d. Green Papaya | Response Mapped: Raw Vegetable/Fruit: 19 |
| 3) | Que comida prefieres? | Question Mapped: Prefieres: 1, Comida: 10 |
| | a. Papas fritas | Response Mapped: Fried food: 12 |
| | b. Helado | Response Mapped: Dessert food: 15 |
| | c. Biste | Response Mapped: Red Meat food: 13 |
| | d. Ensalada | Response Mapped: Raw Vegetable/Fruit: 19 |

Symbolic response mapping is applicable to matching users based on a variety of topics, including, but not limited to: professional interests, hobbies, sports and social issues.

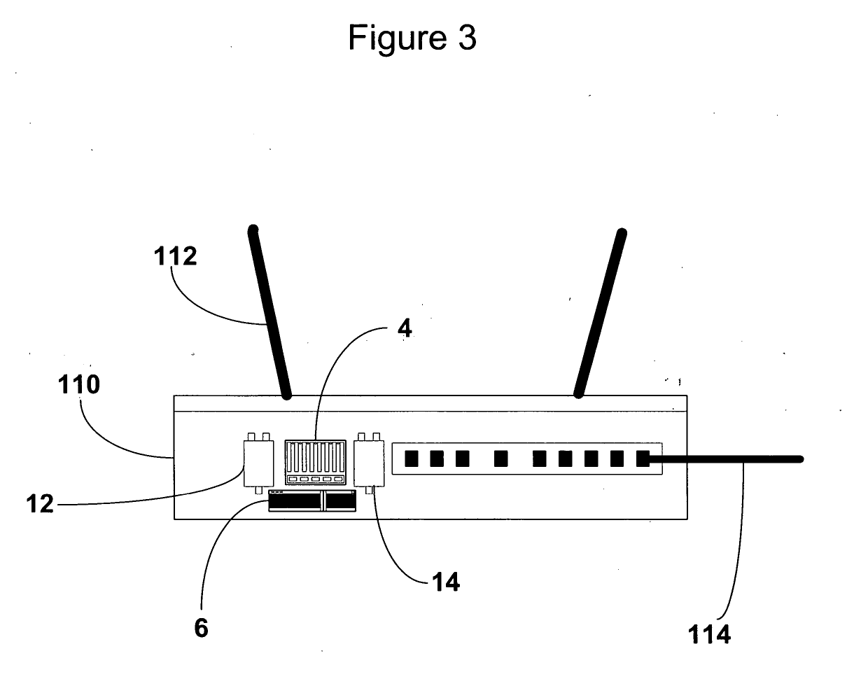

FIG. 3 illustrates a stationary device 10 for interconnecting with wireless communications devices. The stationary device 110 may represent, but is not limited to, a wireless access point, credit card reader, or broadband gateway. Said device when enabled with a processing module 4, memory module 6, personal area communications module 12, and wide area communications module 14, antenna 112 supporting all wireless components or wired wide area connection 114, serves as a stationary data provider for alerts, queue management, gaming and commerce transactions. The applet of the current invention residing in a stationary device 110, communicating via wireless connections to portable devices, as illustrated in FIG. 1 and FIG. 2, within radio proximity enables the provision of alert notification, queuing, gaming, and commercial transactions.

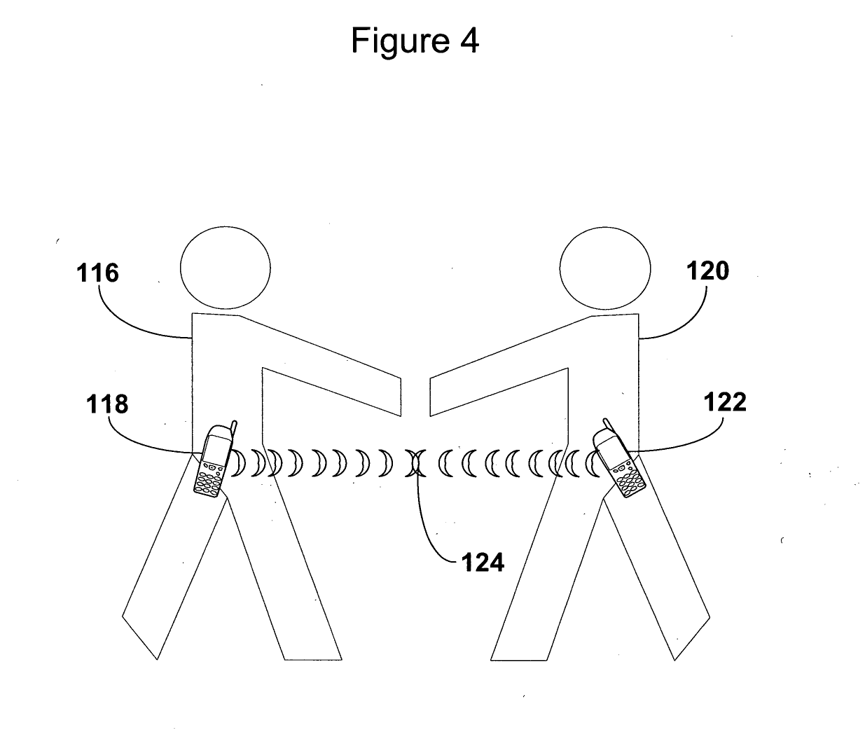

FIG. 4 illustrates a usage case for a match enabled applet as an individual user 116 with a match enabled portable device 118 approaches another individual user 120 also with a second match enabled portable device 122. A first match-enabled portable device 118 signals a second match-enabled portable device 122. A scan session 124 is initiated to establish a match of the criteria by the applets as illustrated in FIG. 2A.

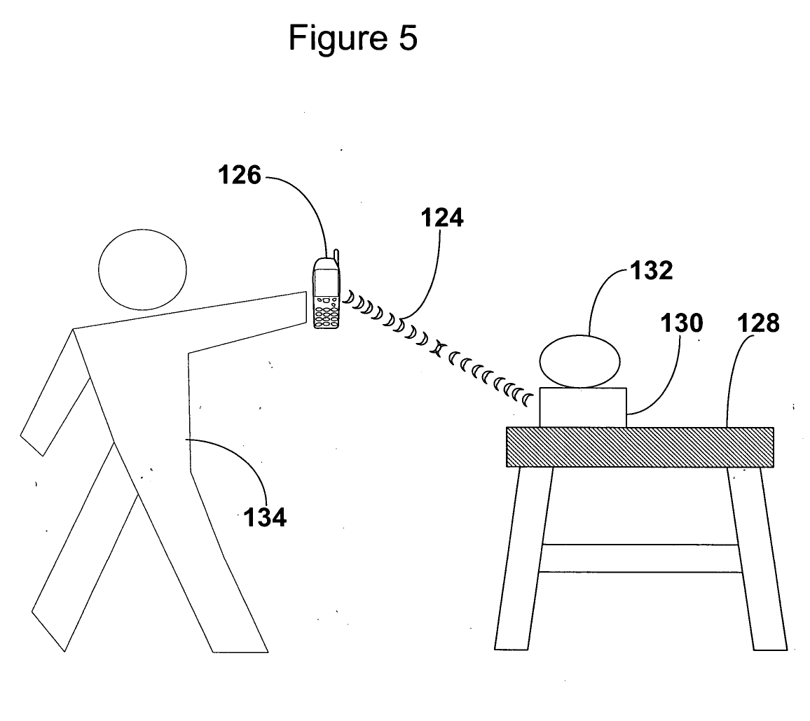

FIG. 5 illustrates a usage case for an alert enabled portable device 126 initiating a scan session 124 with a stationary alert enabled construction barrier 128. In a preferred embodiment of the current invention, the stationary device 110 of FIG. 3 resides in form or concept within the battery support housing 130 supporting the warning light 132. A pedestrian 134 traversing within radio proximity of the construction barrier 128 is alerted to the hazard in the area via audio-visual-tactile cues from the alert enabled portable device 126.

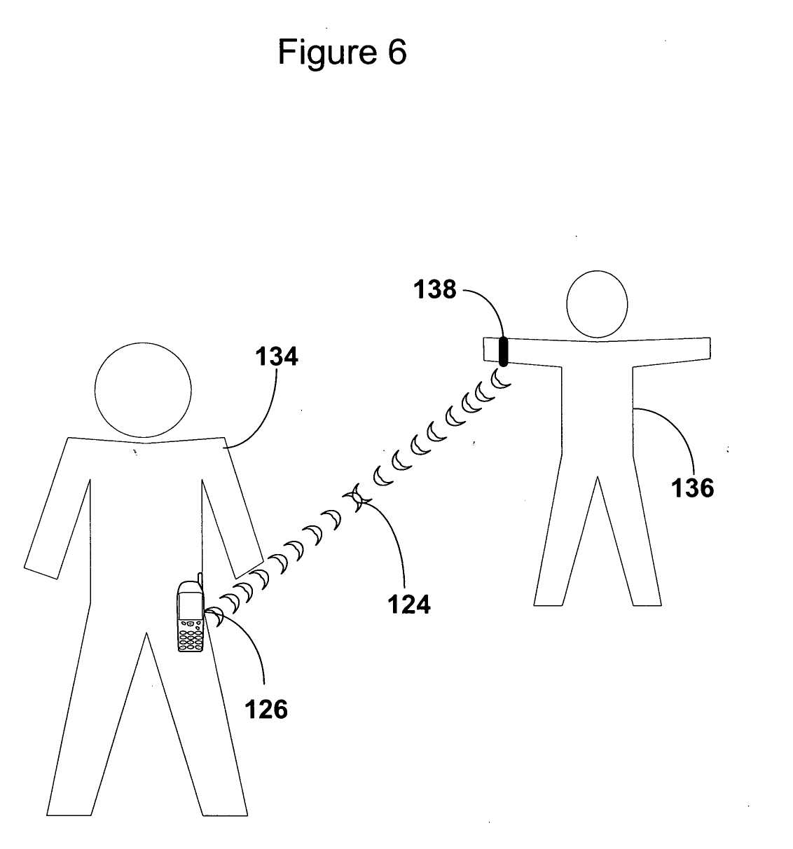

FIG. 6 illustrates a further usage case for an alert enabled portable device 126 carried by an individual user 134 in a public setting. Within radio proximity is a known sex offender 136 with a alert enabled police bracelet 138. A scan session 124 initiates between the alert enabled portable device 126 and the alert enabled police bracelet 138. Notification of the alert is made to the individual user 134 via audio-visual-tactile cues. Anonymity is ensured while the individual user 134 increases vigilance within the surrounding area.

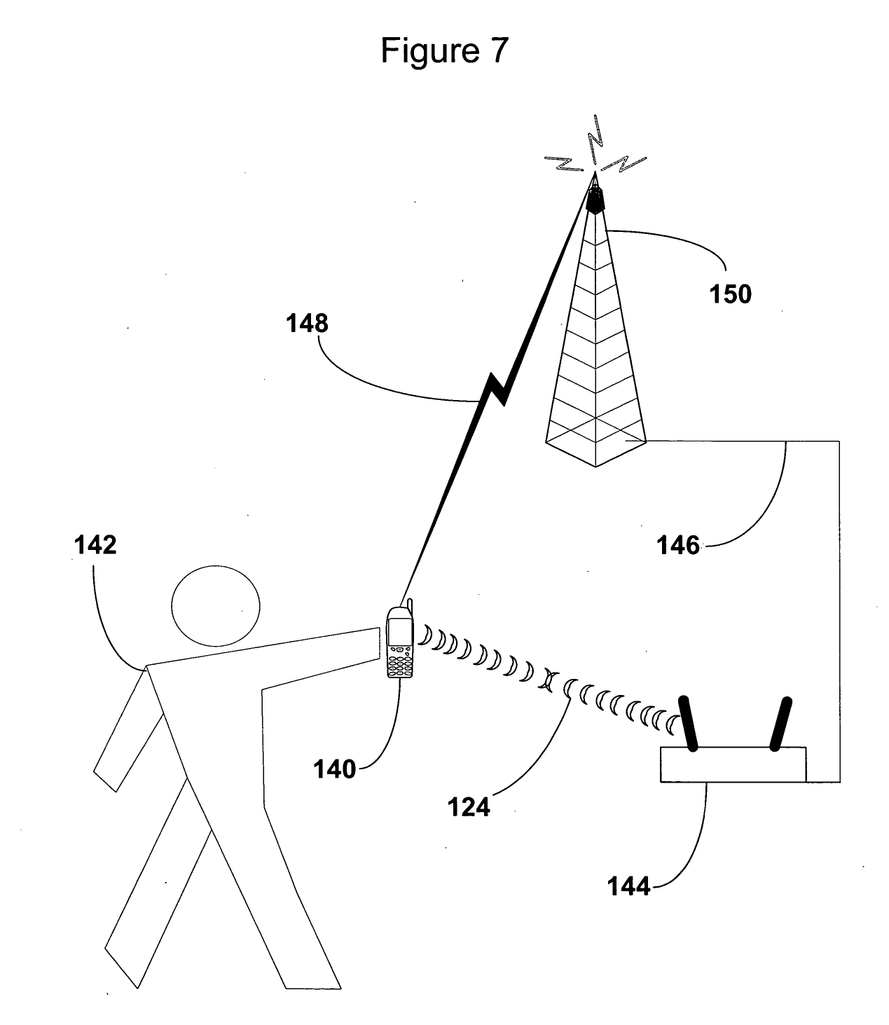

FIG. 7 illustrates a usage case for a queue enabled portable device 140 carried by an individual user 142 entering a restaurant. The queue enabled portable device 140 is prompted to begin a scan session 124 with the restaurant stationary queue management device 144. The individual user 142 requests one seat via the queue enabled portable device 140. The stationary queue management device 144 offers an approximate wait time to the individual user 142 via the queue enabled portable device 140. The individual user 142 accepts and prompts the queue enabled portable device 140 to send contact information to the stationary queue management device 144. The stationary queue management device 144 either tracks seat availability automatically or via manual inputs. When seating is confirmed the stationary queue management device 144 uses a wired connection 146 to place a call 148 via the individual user's mobile phone service 150. The call 148 answered by the individual user 142 offers an automated voice from the stationary queue management device 144 indicating the seat is available. The call 148 almost may take the form of a page, e-mail or other wide area communication. An alert via a session scan 124 back to the queue enabled portable device 140 within radio proximity may also be used as the first method of communication.

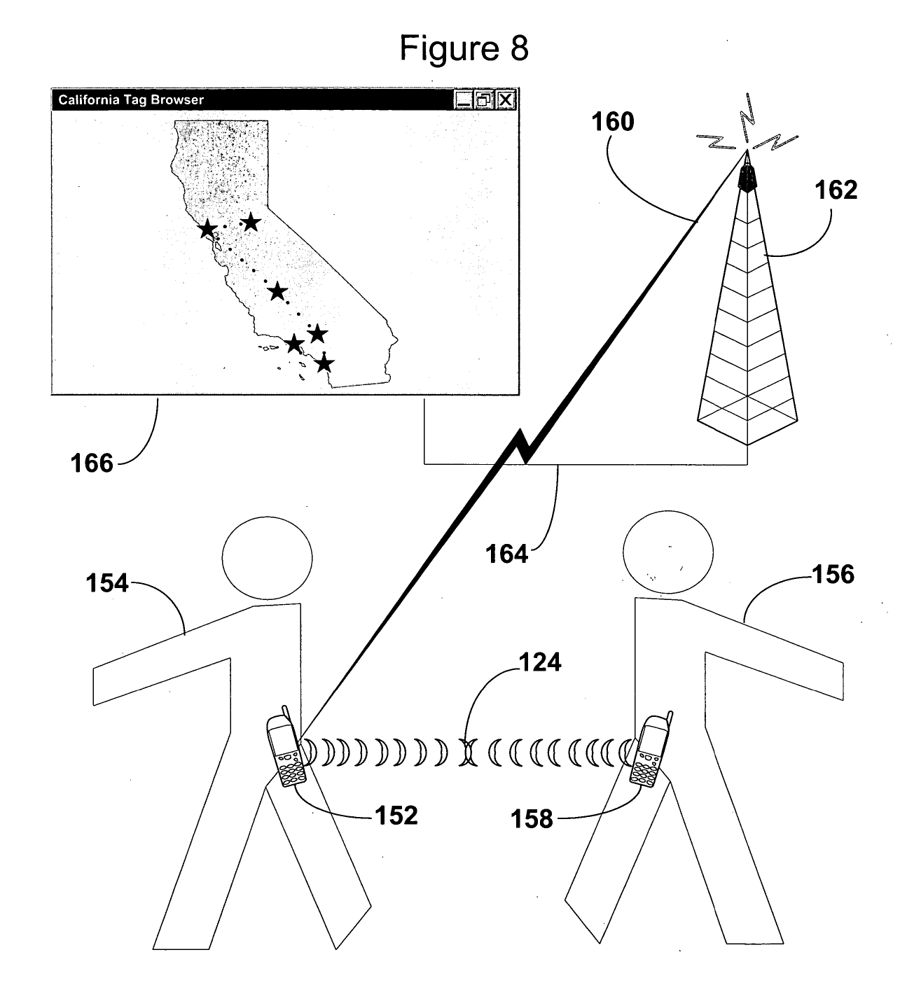

FIG. 8 illustrates a usage case for a gaming enabled portable device 152 carried by an individual user 154. Individual user 154 passes within radio proximity of a second individual user 156 with a second gaming enabled portable device 158. The second gaming enabled portable device 158 carries a gaming token. The first gaming enabled portable device 152 initiates a scan session 124 with the second gaming enabled device 158. The second gaming enabled device 150 authenticates the eligibility of the first gaming enabled portable device 152 to participate in the current game. The second gaming enabled portable device 158 forwards the gaming token to the first gaming enabled portable device 152. The first gaming enabled portable device 152 decrypts the instruction set in the token and initiates a wide area transaction 160 to the gaming service provider 162. The gaming service provider 162 increments the hop counter to check for a winning tag. The token not revealed as a winner prompts the gaming service provider 162 to update 164 the gaming web site 166 with a geographic position change for the token. Interest in the game is maintained by the updates 164 to the gaming web site 166 viewed users.

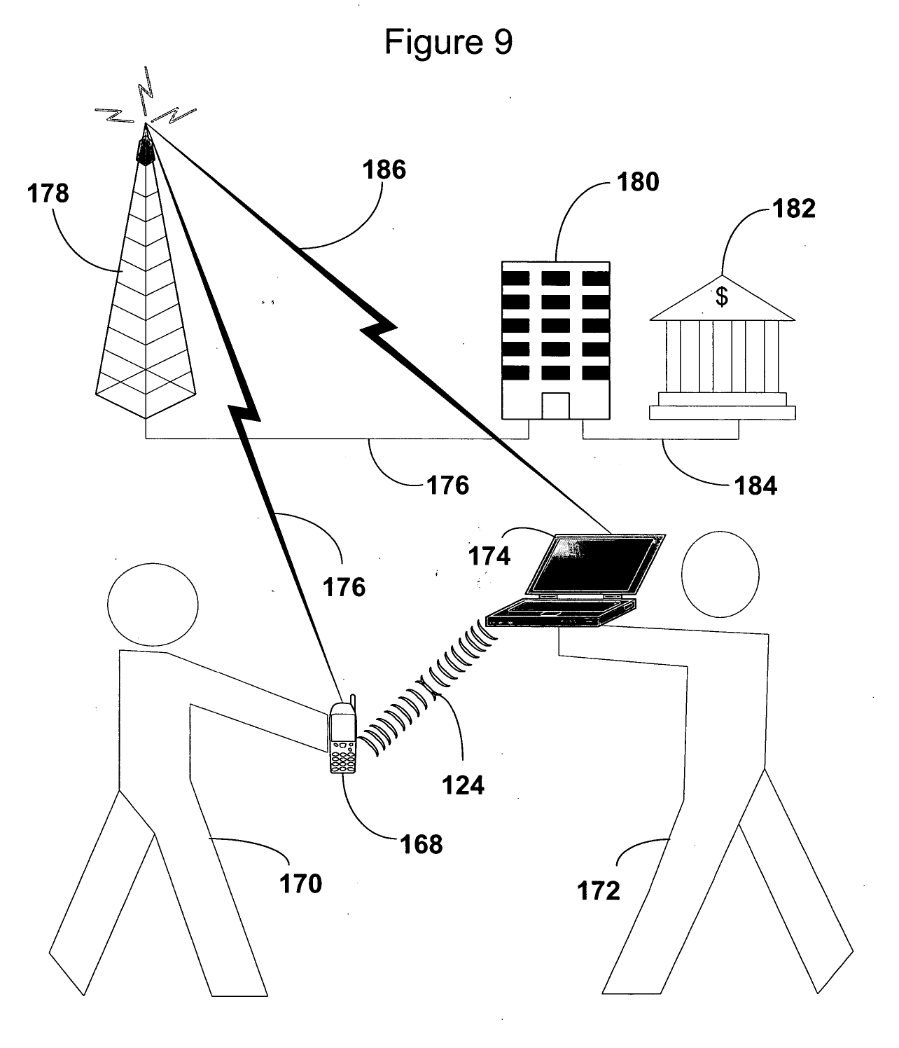

FIG. 9 illustrates a usage case for a commercial transaction enabled portable device 168 carried by an individual user 170. An individual user 170 passes within radio proximity of a seller 172 offering digital content on a second commercial transaction enabled portable device 174. The first commercial transaction enabled portable device 168 connects with the second commercial enabled transaction enabled portable device 174 and both initiate a scan session 124 to compare the offer and ask categories within each applet. The individual user 170 is notified of a match for music offered by the seller 172. The individual user 170 and the seller 172 negotiate price and product specifics. The individual user 170 accepts a price and enters the value into the commercial transaction applet on the enabled portable device 168. The applet of the commercial transaction enabled portable device 168 takes the payment clearinghouse information for the seller 172 from the second commercial transaction enabled portable device 174. The first commercial transaction enabled portable device 168 sends the individual user's 170 billing data in a wide area connection 176 via the wide area service provider 178 to the seller's 172 payment clearinghouse 180. The payment clearinghouse 180 of the seller 172 then bills the financial institution 182 if the individual user 170. The financial institution 182 approves the fund transfer 184 to the payment clearinghouse 180. The payment clearinghouse 180 notifies the seller via a wide area connection 186 of the transaction processing. The seller 172 transfers to files to the individual user 170.

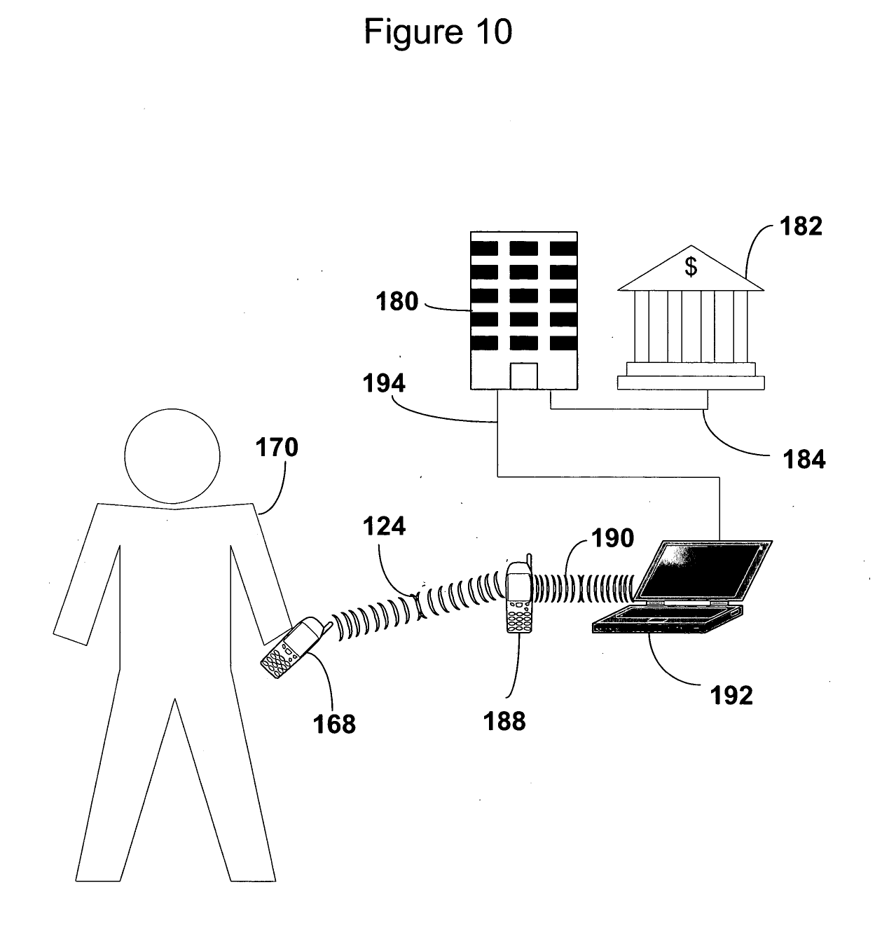

FIG. 10 illustrates a usage case for a commercial transaction enabled portable device 168 carried by individual user 170 as referenced in FIG. 9. In this case the seller's commercial transaction enabled device 188 does not have wide area connection ability. In order to complete the transaction the individual user enters a value for the product into his commercial transaction enabled portable device 168 along with his unique personal identification number which is encrypted into a payment token. The seller's commercial transaction enabled device 188 receives the payment token via a session 124. Later in the day the seller synchronizes 190 the seller's commercial transaction enabled device 188 to a web connected computing device 192. The web connected computing device communicates 194 with the seller's payment clearinghouse 180 and sends the payment token. The seller's payment clearinghouse 180 then bills the financial institution 182 if the individual user 170. The financial institution 182 approves the fund transfer 184 to the payment clearinghouse 180. The payment clearinghouse 180 notifies the seller via the web connected computing device 192 of the transaction processing completion.

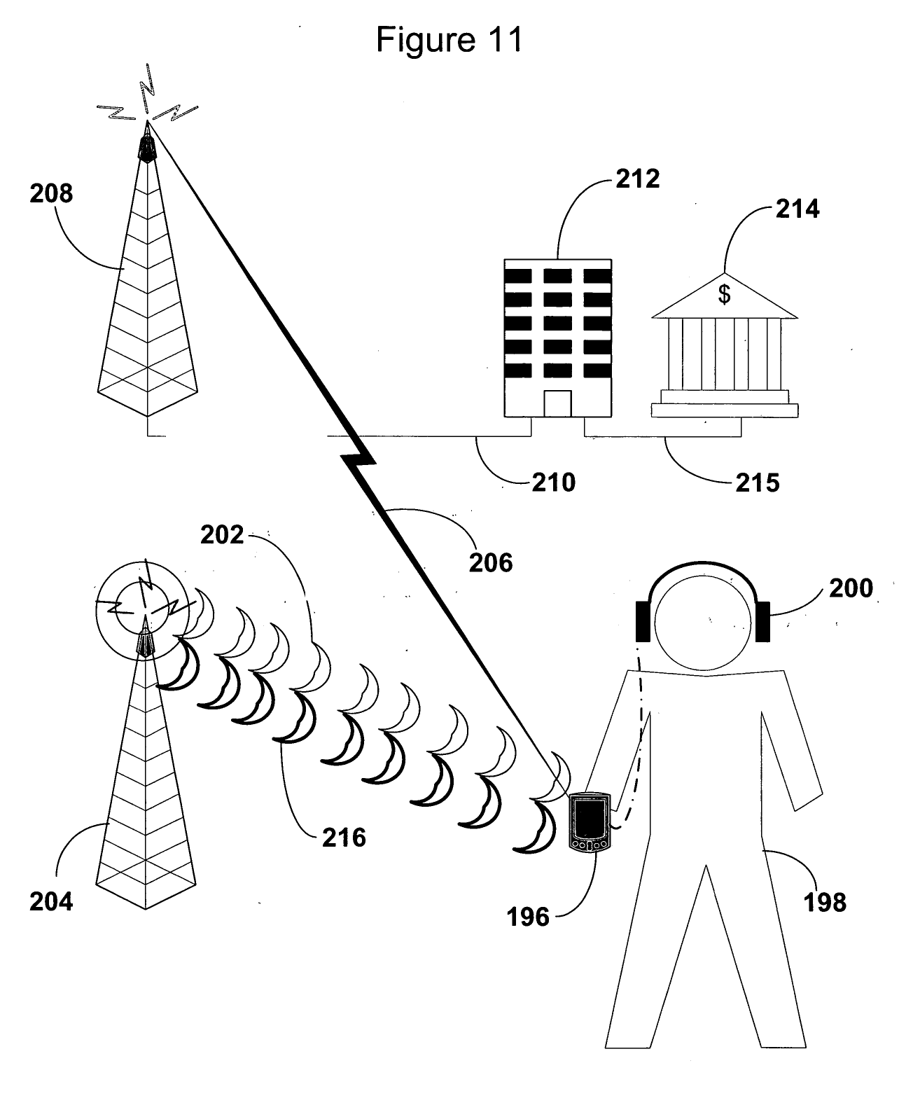

FIG. 11 illustrates a usage case for a commercial transaction enabled portable device 196 carried by an individual user 198. The individual user 198 is listening via headphones 200 to broadcast content 202 from a radio station 204. The individual user 198 enjoys the song and would like to retain a copy to the storage of his commercial transaction enabled portable device 196. With one touch of a button on the commercial transaction enabled portable device 196, a wide area connection 206 is enabled and a time and station indicator is sent to a service provider 208. The service provider 208 sends a payment request 210 to a payment clearinghouse 220, which may be unique to the service rather than the user. The payment clearinghouse 212 bills the individual user's financial institution 214 which transfers the funds 215 to the clearinghouse 212. When payment approval is issued by the clearinghouse 212, the service provider 208 is notified and a key is issued to the individual user 198 through a wide area connection 206 to the commercial transaction enabled portable device 196. The purchased song would be downloaded via a secondary broadcast band 216 in the case of digital radio or via a wide area connection 206 if a secondary broadcast band 216 were not available. The key issued by the service provider would serve as the decryption and usage license for the digital content.

What is claimed:

1. In a system for matching user information to other users and services; via a portable device, comprising a software application, processing module, memory module, personal area communications module, wide area communications module, antenna, input pad, screen and portable power source, with a plurality of other such devices in radio frequency proximity, and a plurality of users of such devices, a method of matching a user of a device with at least one other user of a similarly enabled device, comprising the steps of:
securely storing the characteristic and criteria data of the user on the device and through the system, the characteristic data including a unique identifier for the application, contact information for the user, and match, alert, ask-offer, queue management and gaming criteria for enabling the device to serve the user, the criteria data including all user-defined attributes;
scanning for and announcing of portable devices present in radio proximity using a power optimized timing sequence related to the radius of radio propagation for the personal area communications module on the device and the average walking speed for a person in the environment;
creating secure sessions for transferring data between devices to be processed via coded instruction sets;
providing users the ability to input and define match, alert and notification criteria, contact information, offer-ask items, payment and gaming tokens;
comparing the criteria and characteristic data of a first user with the criteria and characteristic data of at least one other user of the system;
comparing the criteria and characteristic data of a first user with the criteria and characteristic data of another user at least one connection removed from the first user, as in a mesh network environment;
comparing the criteria and characteristic data and application software capability of a first device with the criteria and characteristic data and application software of at least one other device of the system to establish service connectivity;
comparing the criteria and characteristic data and application software capability of a first device with the criteria and characteristic data and application software of another device at least one connection removed from the first device of the system, as in a mesh network environment, to establish service connectivity;
providing information security structure to allow secure retention and transfer of datasets, applications, certificates and tokens, such that security parameters for any embodiment of digital content is user, device, or third party defined.

2. The method according to claim 1, wherein said characteristic data of said user includes symbolic data standardized for geographic, cultural, ethnic and social interpretation, representing user preferences for compatibility matching.

3. The method according to claim 1, wherein said characteristic data of said user includes symbolic data standardized for geographic, cultural, ethnic and social interpretation, representing user preferences for professional, career, hobby and social relationship building.

4. The method according to claim 1, wherein said characteristic data of said user is input with said input pad representing a keypad, keyboard, touchpad, symbolic buttons, touch screens or menu sequence on said portable device.

5. The method according to claim 1, wherein said characteristic data of said user is input via a device not connected to said portable device, and wirelessly conveyed to said portable device after being input elsewhere by said user.

6. The method according to claim 1, wherein said criteria data of said user includes a desired threshold of matched data characteristics before a notification is made to said user of a match in characteristic data with another user or plurality of users.

7. The method according to claim 6, wherein said notification of matched characteristic data is an audio, visual or tactile cue created by the portable device of said user.

8. The method according to claim 1, wherein said application on said portable device of said user negotiates a data processing scheme for load balancing with the application on the portable device of another user to avoid repetitive processing of similar datasets and minimize power consumption.

9. The method according to claim 1, wherein said user enables pre-defined data exchanges between devices with a single action imparted to said input pad upon having said session initiated between two of said portable devices.

10. The method according to claim 1, wherein said user enables a voice communication session between said devices with a single action imparted to said input pad upon having said initial secure session initiated between two of said portable devices

11. The method according to claim 1, wherein said application of said portable device executes commands within the parameters of said portable device without intervention of said user.

12. The method according to claim 11, wherein said parameters of said portable device include use of the wide area communications module by the application to send and receive data transactions and notifications to and from third party service providers, including financial institutions, gaming companies, law enforcement agencies and governmental organizations.

13. The method according to claim 1, wherein eligibility characteristics for creating said session connection between two devices is based upon paid credentials to third parties.

14. The method according to claim 13, wherein said eligibility characteristics are encapsulated in said application of said portable device and said session connections are evaluated and confirmed between two devices without third party intervention.

15. The method according to claim 1, wherein at least one of the devices in the plurality of devices said user may connect to with said portable device is a stationary device providing characteristic data specific to its location.

16. The method according to claim 15, wherein said stationary device connecting to said portable device of said user sends queries for response by said user.

17. The method according to claim 16, wherein said queries include information for queue management, commerce transactions, and gaming.

18. The method according to claim 15, wherein said stationary device offers queue management capability without user intervention.

19. The method according to claim 18, wherein at least two of said stationary devices actively monitor the personal area network for positioning of users relative to seating, counter location, amusement park line formation for user movement through the area.

20. The method according to claim 18, wherein at least two of said stationary devices monitor and compare user movement and calculate estimated times for service based on learned behavior of user movement and positioning at the location.

21. The method according to claim 1, wherein said user-defined criteria for said offer-ask items is wirelessly announced to similarly enabled devices via said personal area communications module and a virtual marketplace is created.

22. The method according to claim 21, wherein a notification to the user of said device alerts to a match on said offer-ask items in said virtual marketplace, said device prompts said user to select to exchange contact information or payment information.

23. The method according to claim 22, wherein selecting said payment information creates a payment transaction initiated by a buyer for an offered product utilizing financial information synchronized from a portable device of a seller to said device of a buyer.

24. The method according to claim 23, wherein said payment transaction is conveyed across a wide area connection to a payment clearinghouse for credit to an account of said seller, and confirmation return to said seller.

25. The method according to claim 24, wherein said payment transaction is encapsulated in a secure token issued by a buyer and transferred to a portable device of a seller.

26. The method according to claim 25, wherein said token on said portable device of said seller is later synchronized through a network connection to a payment clearinghouse for credit.

27. The method according to claim 1, wherein said wide area communications module, of said portable device, receives digital and analog broadcast streams.

28. The method according to claim 27, wherein said digital and analog broadcast streams represent content which said user of said portable device listens or views in near real time and which said user may purchase for personal use by utilizing said application on said portable device and indicating a desire to purchase the content via a single input on said input pad of said portable device.

29. The method according to claim 28, wherein said application creates a wireless data transaction communicated across said wide area communications module; said wireless data transaction encapsulates a unique application identifier, a time and frequency band stamp, and user billing information to a clearinghouse for payment completion and content rights management.

30. The method according to claim 29, wherein said clearinghouse completes said payment transaction for said content using said billing information for said user, and forwards a key token to a portable device of said user; said key token representing a code which allows for decryption and fair use of said purchased content.

31. The method according to claim 30, wherein said purchased content is secondarily streamed or broadcast to said portable device belonging to said user over a second frequency band outside of a range utilized for the original broadcast stream to said portable device.

32. The method according to claim 31, wherein said secondary broadcast over said second frequency band is timed to commence after said original broadcast to ensure additional users listening or viewing said content near the end of said original broadcast are able to create a purchase transaction for said content and synchronization of said secondary broadcast after said original broadcast allows time for a single broadcast to feed said content to said additional users.

33. The system according to claim 1, wherein said portable device also incorporates functionality of a mobile phone, personal digital assistant (PDA), MP3 player, laptop, pager, key fob, or other commonly carried digital device.

34. The system according to claim 1, wherein said software application is written in any common language for mobile and small form factor devices.

35. The system according to claim 1, wherein said processing module runs instruction sets from any common programming language for mobile and small form factor devices, and may be an application specific integrated circuit.

36. The system according to claim 1, wherein said memory module retains application and data sets when the device is powered down.

37. The system according to claim 1, wherein said personal area communications module creates a wireless personal area network through radio frequency links, based on, but not limited to current standards such as, Bluetooth, Wifi, and Zigbee.

38. The system according to claim 1, wherein said wide area communications module creates a wireless connection over large distances to fixed cellular infrastructure, similar but not limited to standards such as GSM, GPRS, EDGE, CDMA, WCDMA, paging networks, Mobitex, and CDPD

39. A system for matching a first user with at least one other of a plurality of users of the system wherein each user has a portable device, comprising:
A software application to manage interactions and data between the first user and a plurality of users on the system;
A processing module to run the software application instruction sets and process data;
A memory module where application and data are stored;
A personal area communications capability for interconnection of devices within radio proximity;
A wide area communications capability for interconnections with networks of resources outside personal area radio proximity;
An input medium to configure user-defined data;
An output screen to visually relay data to the user;
An audio, visual and tactile cue capability to notify the user;
A software application containing one or more application sub-systems or applets, which load to the device independent of the whole, and enable the device to create sessions with other applets across radio frequency communications;
An applet for matching user data characteristics to a plurality of users in radio proximity;
An applet for alerting the device user to vigilance in the personal area;
An applet providing gaming through the conveyance of tokens between a plurality of users;
An applet providing queue management capability in conjunction with stationary devices enabled with personal and wide area communications capability;
An applet for transacting commerce through offer-ask data matching via personal area communications and in conjunction with broadcast or streaming content and wide area communications;
A software application which loads once to the device and whose sub-systems, or applets, are enabled by triggers sent over a wide area communication transaction providing keys to enable functionality for matching, alerting, gaming, queuing and commerce transactions.

40. The system of claim 39, wherein said matching applet utilizes symbolic data to standardize user matching capability across geographic, cultural, ethnic and social groups.

41. The system according to claim 39, wherein said matching applet utilizes keyword references to provide match notifications.

42. The system according to claim 39, wherein said input medium represents a keypad, keyboard, touchpad, symbolic buttons, touch screens or menu sequence on said portable device.

43. The system according to claim 39, wherein said user-defined data may be downloaded to said portable device via said personal area communication capability and said wide area communication capability.

44. The system according to claim 39, wherein said user-defined data includes configurations for said notification cues, including match thresholds, audio volume control, vibrate settings and power consumption levels.

45. The system according to claim 39, wherein said applets in said sessions with other applets negotiate a data processing scheme for load balancing.

46. The system according to claim 39, wherein said user transfers pre-configured data between applets after session initiation, with a single action imparted to said input medium.

47. The system according to claim 39, wherein said user enables a voice communication session between applets after session initiation, with a single action imparted to said input medium

48. The system according to claim 39, wherein said applet executes commands within the parameters of said portable device without intervention of said user.

49. The system according to claim 48, wherein said parameters include use of the wide area communications capability by the application to interact with third party service providers.

50. The system according to claim 39, wherein said applets require subscription payments in order to retain valid keys and function accordingly.

51. The system according to claim 50, wherein said applets are able to mutually authenticate a valid subscription key of other applets within radio proximity.

52. The system according to claim 39, wherein said stationary device connecting to said portable device relay queries for response by said user.

53. The system according to claim 39, wherein said stationary device offers queue management capability without user intervention.

54. The system according to claim 53, wherein at least two of said stationary devices triangulate movements with said portable device and maps seating availability and line flows through said movement patterns.

55. The system according to claim 54, wherein said movement patterns are utilized by applets in said stationary devices to calculate estimated wait times for users based on learned behavior from said movement patterns and device positioning at the location.

56. The system according to claim 39, wherein said offer-ask items are wirelessly announced by said applet to similarly enabled applets with said personal area communications capability.

57. The system according to claim 56, wherein a match on said offer-ask items is followed by a prompt from said applet to a user to relay contact information or create a payment transaction.

58. The system according to claim 57, wherein said applet applies pre-configured user information from a buyer and data transferred from a seller to create a payment transaction over a wide area communication link.

59. The system according to claim 58, wherein confirmation of said payment transaction is returned to said applet of said seller.

60. The system according to claim 57, wherein said payment transaction is encapsulated in a secure token issued by said buyer and transferred to said applet of said seller.

61. The system according to claim 60, wherein said token on said applet of said seller is later synchronized through a network connection to a payment clearinghouse for credit.

62. The system according to claim 39, wherein said broadcast streams represent content occurs in near real time and is available for purchase by said user.

63. The system according to claim 62, wherein said applet creates a data transaction across said wide area communications capability; said data transaction encapsulates a unique applet identifier, a time and frequency band stamp, and user billing information; said data transaction is forward to a third party for payment completion and content rights management.

64. The system according to claim 63, wherein payment confirmation is received by said applet accompanied by a key to decrypt and use the purchased content.

65. The system according to claim 64, wherein said purchased content is delivered via a second broadcast stream via a frequency band other than the frequency band of the original broadcast stream, and said key decrypts and permits usage, storage and transfer of said content.

66. The system according to claim 65, wherein said second broadcast stream is timed to start after said original broadcast stream to allow transactions for the content transpiring at the end of the first broadcast stream to be fulfilled by said second broadcast stream.

67. A system for offering person to person, and person to service provider, wireless communication utilizing power optimized radio frequency scanning and data processing, comprising:
Communications and processing services for symbolic matching of personal characteristics;
Communications and processing services for offering alerts to persons in radio proximity;
Communications and processing services for token tag gaming and notification to a service provider;
Communications and processing services for radio proximity queue management and customer flow monitoring using radio triangulation;
Communications and processing services for commercial transactions with real time or time displaced payment completion;
Communications and processing services for broadcast content purchases using secondary band downloads.
